(19) United States
(12) Patent Application Publication
(10) Pub. No.: US 2023/0160446 A1
(43) Pub. Date: May 25, 2023

(54) BRAKE PAD FOR DISC BRAKE

(71) Applicant: MANDO CORPORATION, Pyeongtaek-si (KR)

(72) Inventors: Sudhirkumar S KARAJGI, Gurgaon (IN); Prakash D. SUNKE, Gurgaon (IN)

(21) Appl. No.: 17/884,544

(22) Filed: Aug. 9, 2022

(30) Foreign Application Priority Data
Aug. 9, 2021 (KR) 10-2021-0104858

(51) Int. Cl. F16D 65/097; F16D 55/226

(52) U.S. Cl. CPC F16D 65/0971; F16D 55/226

(57) ABSTRACT

Disclosed herein a brake pad for a disk brake. The brake pad for a disk brake pressing a disc rotated together with a wheel includes a pad plate pressed by a piston moving forward and backward by a braking hydraulic pressure; a friction pad attached to one side surface of the pad plate and in contact with the disk; and a shim member integrally formed with the pad plate to protrude from the other side surface of the pad plate.

### CROSS-REFERENCE TO RELATED APPLICATION(S)

This application is based on and claims priority under 35 U.S.C. § 119 to Korean Patent Application No. 10-2021-0104858, filed on Aug. 9, 2021, in the Korean Intellectual Property Office, the disclosure of which is incorporated herein by reference in its entirety.

### TECHNICAL FIELD

The present disclosure relates to a brake pad for a disc brake, and more particularly, to a brake pad for a disc brake in which a shim provided to reduce noise and vibration during braking is integrally provided.

### BACKGROUND

In general, a disc brake device mounted on a vehicle is a device for decelerating, stopping, or maintaining a stopped state of a vehicle while driving, and obtains braking force by strongly pressing friction pads against opposite sides of a disk-shaped disk rotating together with a wheel.

Such a disc brake includes a caliper housing having a built-in piston to move forward and backward by braking hydraulic pressure, a carrier fixed to a vehicle body and to which the caliper housing is slidably coupled, and a pair of brake pads having a pad plate slidably installed on the carrier.

Here, a shim is installed on an outer surface of the brake pad to prevent heat and vibration generated during braking from being transmitted to a piston and a caliper housing. A configuration in which such a shim is installed on a pad plate is disclosed in Korean Patent Laid-Open No. 10-1999-0080950 and Japanese Patent No. 6284831.

According to the above document, to fix the shim to the pad plate, a structure is provided in which a plurality of fixing protrusions or drilled holes are provided and coupled to each other. As a result, assembly for fixing the shim to the pad plate and manufacturing time accordingly increases.

Furthermore, a force for supporting a shim installed on the brake pad due to the repeated braking operation of a brake is reduced, so that the shim is separated from the brake pad.

### SUMMARY

An aspect of the disclosure is to provide a brake pad for a disc brake capable of reducing assembly and manufacturing time by integrally forming a shim on a pad plate, and also preventing the shim from being separated from the pad plate.

Additional aspects of the disclosure will be set forth in part in the description which follows and, in part, will be obvious from the description, or may be learned by practice of the disclosure.

In accordance with an aspect of the disclosure, a brake pad for a disk brake pressing a disc rotated together with a wheel includes a pad plate pressed by a piston moving forward and backward by a braking hydraulic pressure; a friction pad attached to one side surface of the pad plate and in contact with the disk; and a shim member integrally formed with the pad plate to protrude from the other side surface of the pad plate.

The shim member may be formed only in a portion in contact with the piston having an opened front end surface.

A plurality of shim members may be provided, the plurality of shim members may be spaced apart from each other at predetermined intervals to have a ring shape, and a slit may be formed between the plurality of shim members.

A layer made of a rubber material may be provided on the shim member.

A coating layer made of a steel material may be formed on a surface of the shim member.

In accordance with another aspect of the disclosure, a brake pad for a disk brake provided to press a disc rotated together with a wheel includes a pad plate pressed by a finger part of a caliper housing during a braking operation; a friction pad attached to one side surface of the pad plate and in contact with the disk; and a shim member integrally formed with the pad plate to protrude from the other side surface of the pad plate.

The shim member may be formed only in a portion in contact with the finger part.

A plurality of shim members may be provided, the plurality of shim members may be spaced apart from each other at predetermined intervals to have a ring shape, and a slit may be formed between the plurality of shim members.

A layer made of a rubber material may be provided on the shim member.

A coating layer made of a steel material may be formed on a surface of the shim member.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a side cross-sectional view illustrating a disc brake provided with a brake pad according to an exemplary embodiment of the present disclosure;

FIG. 2 is a view illustrating a brake pad for a disc brake according to an exemplary embodiment of the present disclosure;

FIG. 3 is a view illustrating a state in which a piston is in contact with a brake pad for a disc brake according to an exemplary embodiment of the present disclosure;

FIG. 4 is a cross-sectional view illustrating a brake pad for a disc brake according to an exemplary embodiment of the present disclosure;

FIG. 5 is an enlarged view of a part A of FIG. 4.

FIG. 6 is a view illustrating a brake pad for a disc brake according to another embodiment of the present disclosure; and

FIG. 7 is a view illustrating a state in which a finger part is in contact with a brake pad for a disc brake according to another exemplary embodiment of the present disclosure.

### DETAILED DESCRIPTION

Hereinafter, the embodiments of the disclosure will be described in detail with reference to accompanying drawings. It should be understood that the terms used in the specification and the appended claims should not be construed as limited to general and dictionary meanings, but interpreted based on the meanings and concepts corresponding to technical aspects of the disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

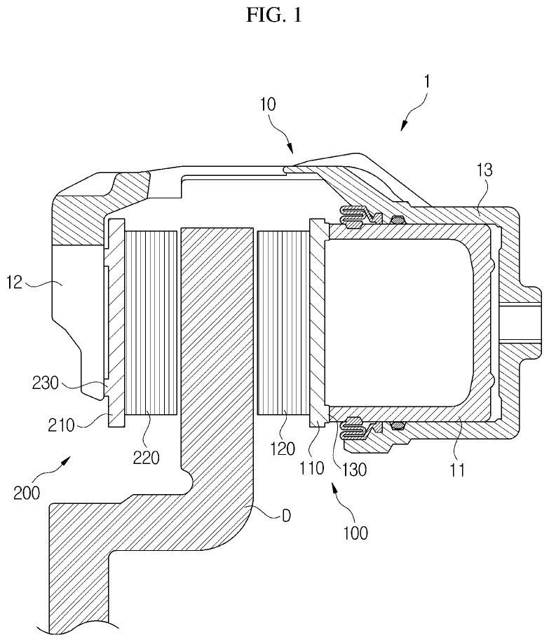

FIG. 1 is a side cross-sectional view illustrating a disc brake provided with a brake pad according to an embodiment of the disclosure.

Referring to FIG. 1, brake pads 100 and 200 according to an embodiment of the disclosure may be installed and used in a disc brake 1 to perform a braking operation by pressing a disc D rotating together with a wheel of the vehicle. In other words, the brake pads 100 and 200 may be provided as a pair to face each other with the disk D interposed therebetween. The brake pads 100 and 200 may be divided into an inner brake pad 100 that is pressed by a piston 11 to be described later, and an outer brake pad 200 that is pressed by a finger part 12 of a caliper housing 10. The inner brake pad 100 and the outer brake pad 200 differ only in a formation structure of shim members 130 and 230, but the remaining thereof are the same. The brake pad 100 according to an embodiment of the disclosure relates to the inner brake pad 100, and will be described separately from the outer brake pad 200.

The disc brake 1 on which the brake pads 100 and 200 are installed will be briefly described first. The disc brake 1 may include the caliper housing 10 in which the piston 11 with an opened front end surface is installed so as to move forward and backward by braking hydraulic pressure, and a carrier (not shown) that is fixed to the vehicle body and coupled slidably to the caliper housing 10.

A cylinder 13 in which the piston 11 is installed is provided on a rear portion of the caliper housing 10, and a pair of finger parts 12 bent downwardly are provided on the front portion thereof. When the braking hydraulic pressure is supplied through the rear portion of the caliper housing 10, the piston 11 provided in the cylinder 13 pushes the inner brake pad 100, and in turn the finger part 12 provided on the front portion of the caliper housing 10 pushes the outer brake pad 200 against the disk D. Accordingly, the pair of brake pads 100 and 200 press opposite sides of the disk D, thereby performing braking. Since the disc brake 1 is a well-known technology, a detailed description thereof will be omitted.

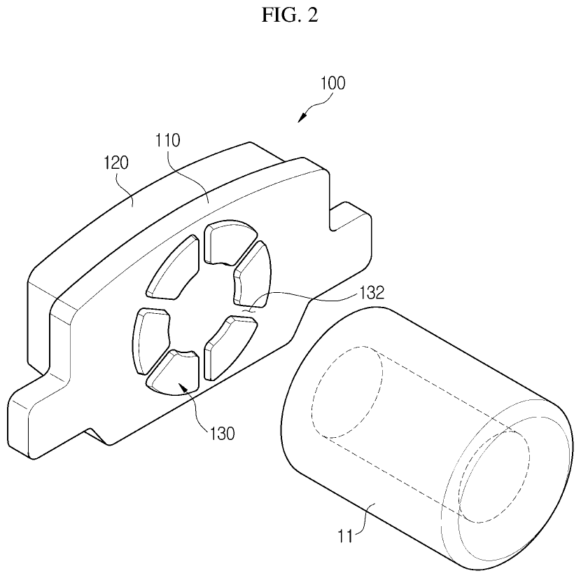

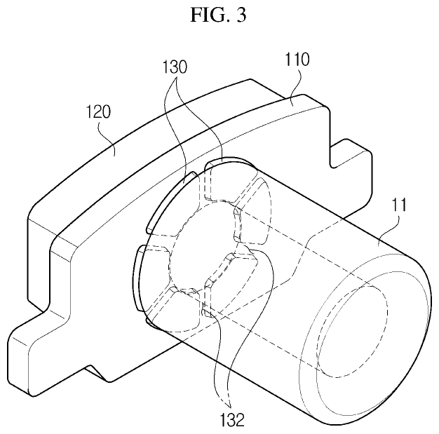

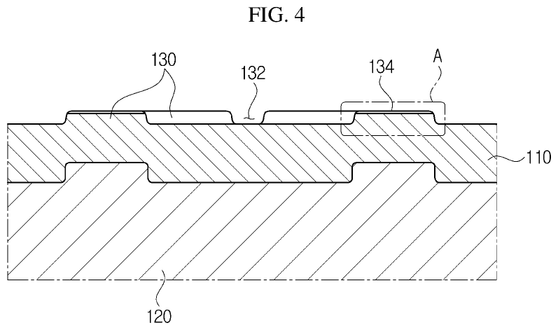

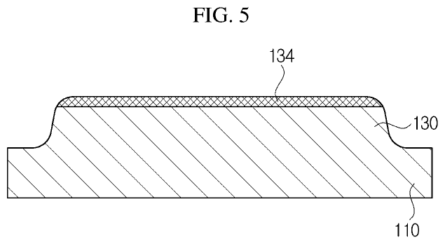

FIG. 2 is a view illustrating a brake pad for a disc brake according to an embodiment of the disclosure, FIG. 3 is a view illustrating a state in which the piston is in contact with a brake pad for a disc brake according to an embodiment of the disclosure, and FIG. 4 is a cross-sectional view illustrating a brake pad for a disc brake according to an embodiment of the disclosure, and FIG. 5 is an enlarged view of a part A of FIG. 4.

Referring to FIGS. 1 to 5, the brake pad 100 according to an embodiment of the disclosure is the inner brake pad 100 pressed by the piston 11, and may include a pad plate 110, a friction pad 120 attached to one side surface of the pad plate 110, and a shim member 130 integrally provided on the other side surface of the pad plate 110. In other words, the friction pad 120 and the shim member 130 are formed on opposite surfaces of the pad plate 100.

The shim member 130 serves to reduce braking noise when pressed by the piston 11 as well as prevent vibration and frictional heat due to braking from being transmitted to the caliper housing 10 through the piston 11.

More specifically, the shim member 130 is formed to protrude from the other side of the pad plate 110, and may be integrally formed with the pad plate 110. In other words, the shim member 130 may be formed to have one body with the pad plate 110. The shim member 130 may be formed only in a portion in contact with the piston 11. For example, because the front end surface of the piston 11 pressing the pad plate 110 is provided to have an open shape, the shim member 130 may be provided to have a ring shape.

As shown in drawings, the shim member 130 may be formed in plurality. Accordingly, the plurality of shim members 130 may be disposed to be spaced apart from each other at predetermined intervals so as to have a ring shape, and thus a slit 132 may be formed between the plurality of shim members 130.

The slit 132 prevents shim members 130 from forming a vacuum with the surface in contact with the piston 11 when the plurality of shim members 130 are pressed by the piston 11. Furthermore, the slit 132 generates a flow of air to dissipate heat when the shim member 130 is pressed, as well as cool the brake pad 100, the piston 11, and the boot installed in the piston 11, and the like, to prevent breakage from thermal damage.

Additionally, the fact that the shim member 130 does not have a single ring shape, but is provided with a plurality of slits 132 is because it has a heat dissipation function and at the same time, obtains an effect such as volume reduction and material cost reduction due to formation of the shim member 130.

Meanwhile, a layer 134 made of a rubber material may be provided on the plurality of shim members 130. The layer 134 may be provided integrally with the shim member 130, and may be provided on a portion in contact with the piston 11. Accordingly, noise may reduce during braking operation.

Although not shown, a coating layer made of a steel material may be formed on the surface of the shim member 130. The coating layer may serves to receive heat and dissipate heat. Such the coating layer may be used so as to be laminated together with the above-described rubber material layer 134.

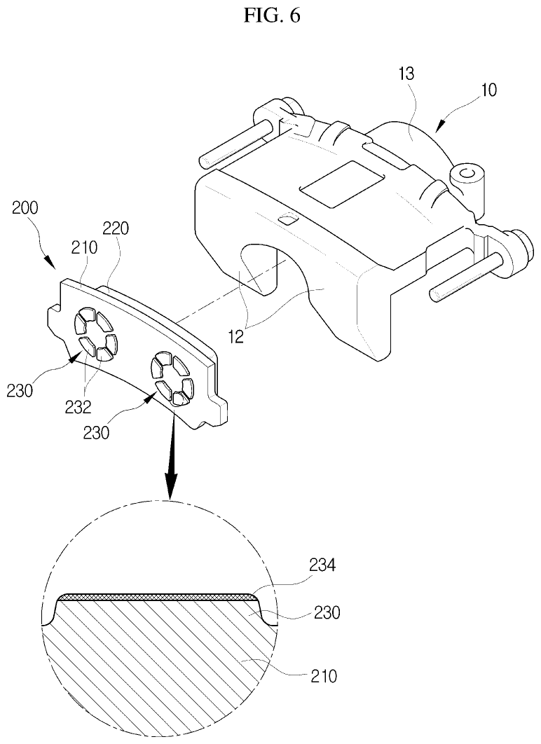

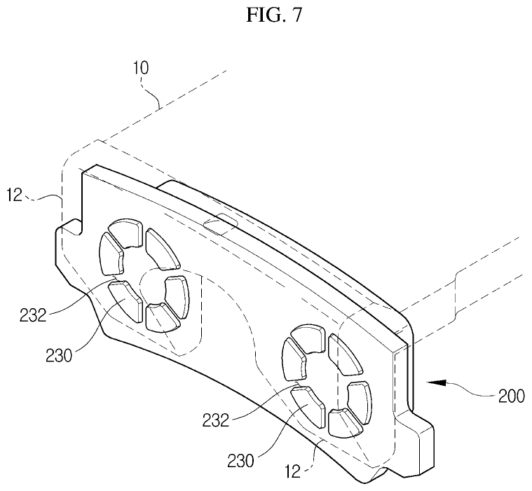

The brake pad 100 as described above relates to the inner brake pad 100 pressed by the piston 11, and the outer brake pad 200 pressed by the finger part 12 of the caliper housing 10 may be provided with a shim member 230 having a shape different from that of the inner brake pad 100. Such the outer brake pad 200 is specifically illustrated in FIGS. 6 and 7.

FIG. 6 is a view illustrating a brake pad for a disc brake according to another embodiment of the disclosure, and FIG. 7 is a view illustrating a state in which the finger part is in contact with the brake pad for the disc brake according to another embodiment of the disclosure. Here, the same reference numerals as in the drawings shown above refer to members that perform the same functions.

Referring to FIGS. 1, 6, and 7, the brake pad 200 according to another embodiment of the disclosure is the outer brake pad 200 pressed by the finger part 12, and may include a pad plate 210, a friction pad 220 attached to one side surface of the pad plate 210, and a shim member 230 integrally provided on the other side surface of the pad plate 210. The shim member 230 serves to not only reduce braking noise when pressed by the finger part 12, but also prevent vibration and frictional heat due to braking from being transmitted to the caliper housing 10 through the finger part 12.

More specifically, the shim member 230 is formed to protrude from the other side of the pad plate 210, and may be integrally formed with the pad plate 210. In other words, the shim member 230 may be formed to have one body with the pad plate 210. The shim member 230 may be formed only in a portion in contact with the finger part 12. For example, because the finger parts 12 for pressing the pad plate 210 are provided as a pair, the shim member 230 may be provided on both sides of the pad plate 210 relative to a center of the other side thereof. In this case, each of the shim members 230 may be divided into a plurality so as to have a ring shape. As illustrated in drawings, the plurality of shim members 230 respectively provided on both sides of the brake pad 200 may be provided to have a ring shape. Furthermore, a slit 232 may be formed between the plurality of ring-shaped shim members 230. Accordingly, as described above, when the shim member 230 is pressed by the finger part 12 heat may be dissipated.

A rubber layer 234 may be provided on the shim member 230 provided on the outer brake pad 200, as well as a steel coating layer (not shown) may be formed thereon.

Meanwhile, the plurality of shim members 230 are provided in a ring shape as an example, but the disclosure is not limited thereto, and may have any shape as long as the slit 232 is formed so as to be in contact with the pressing member.

As is apparent from the above, various embodiments of the disclosure may provide the brake pad for the disc brake capable of shortening assembly and manufacturing time of the shim member compared to the prior art by integrally forming the shim member and the pad plate.

Furthermore, various embodiments of the disclosure may provide the brake pad for the disc brake capable of preventing the shim member from being separated from the pad plate by integrally forming the shim member and the pad plate.

As described above, although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A brake pad for a disk brake pressing a disc rotated together with a wheel, comprising:
a pad plate pressed by a piston moving forward and backward by a braking hydraulic pressure;
a friction pad attached to one side surface of the pad plate and in contact with the disk; and
a shim member integrally formed with the pad plate to protrude from the other side surface of the pad plate.

2. The brake pad of claim 1, wherein the shim member is formed only in a portion in contact with the piston having an opened front end surface.

3. The brake pad of claim 1, wherein a plurality of shim members are provided,
the plurality of shim members are spaced apart from each other at predetermined intervals to have a ring shape, and
a slit is formed between the plurality of shim members.

4. The brake pad of claim 1, wherein a layer made of a rubber material is provided on the shim member.

5. The brake pad of claim 1, wherein a coating layer made of a steel material is formed on a surface of the shim member.

6. A brake pad for a disk brake provided to press a disc rotated together with a wheel, comprising:
a pad plate pressed by a finger part of a caliper housing during a braking operation;
a friction pad attached to one side surface of the pad plate and in contact with the disk; and
a shim member integrally formed with the pad plate to protrude from the other side surface of the pad plate.

7. The brake pad of claim 6, wherein the shim member is formed only in a portion in contact with the finger part.

8. The brake pad of claim 6, wherein a plurality of shim members are provided,
the plurality of shim members are spaced apart from each other at predetermined intervals to have a ring shape, and
a slit is formed between the plurality of shim members.

9. The brake pad of claim 6, wherein a layer made of a rubber material is provided on the shim member.

10. The brake pad of claim 6, wherein a coating layer made of a steel material is formed on a surface of the shim member.
